(19) United States
(12) Patent Application Publication
(10) Pub. No.: US 2020/0013243 A1
(43) Pub. Date: Jan. 9, 2020

(54) SYSTEMS AND METHODS FOR ENHANCED CYBER SECURITY BY DATA CORRUPTION DETECTION MONITORING

(71) Applicant: HONEYWELL INTERNATIONAL INC., Morris Plains, NJ (US)

(72) Inventors: James Alexander NICHOLLS, Glendale, AZ (US); John STOKELY, Albuquerque, NM (US); Dereck CLARK, Glendale, AZ (US); Nina VAJDA, Phoenix, AZ (US); Yasuo ISHIHARA, Kirkland, WA (US); Ramyendu DATTA, Goodyear, AZ (US)

(21) Appl. No.: 16/027,059

(22) Filed: Jul. 3, 2018

(51) Int. Cl. G07C 5/08; G07C 5/00

(52) U.S. Cl. CPC G07C 5/0808; H04L 67/12; G07C 5/008; G07C 5/0816

(57) ABSTRACT

Systems and methods are disclosed for detecting data corruption in vehicle data systems. Systems and methods of detecting data corruption or tampering in vehicle data systems may include steps for receiving first electronic navigational plan data, the first electronic navigational plan data comprising a plurality of waypoints, and storing the first electronic navigational plan data in a data store. Systems and methods may further comprise receiving second electronic navigational plan data from a vehicle management system, the second electronic navigational plan data comprising a second plurality of waypoints, and, upon determining a discrepancy between the first plurality of waypoints and the second plurality of waypoints, generating an alert indicating possible data corruption in the second electronic navigational plan.

### TECHNICAL FIELD

Various embodiments of the present disclosure relate generally to detecting data corruption in data systems and, more particularly, to monitoring data systems in vehicles for errors, data corruption and data tampering.

### BACKGROUND

Vehicles of all types are becoming increasingly complex, as they are fitted with network connections, automated operation components (e.g., “auto-pilot” or “self-driving” features), connected safety and security features, and the like. As vehicles become increasingly complex and connected, a range of security issues have become more prevalent. These issues include both physical and cyber security issues from actors both inside and outside the vehicle operating organization.

In the field of aircraft vehicles, in particular, a concern in providing aircraft data security involves ensuring that any databases, for example the flight management system (FMS) navigation database and/or terrain and obstacle databases for synthetic vision display, are not maliciously tampered with. Cyber security issues may result in aircraft sensors being corrupted such that misleading aircraft guidance or other data is provided to the aircrew or autopilot.

As aircraft systems become increasingly connected, not only with each other, but also with cabin entertainment and off-board communication systems, the number of paths or threat vectors for cyber security concerns are increasing. Even maintenance activities face increased vulnerability to cyber security threats. For example, the FMS navigation database may need to be updated, for example monthly, and these databases may be distributed via the Internet rather than via physical media. Even without aircraft datalink connectivity, it may be possible for a malicious actor with physical access to the aircraft to deliberately corrupt a database in a subtle, but malicious manner and install it in the aircraft. Mechanisms to prevent errors in the electronic transmission of data may include parity checks, error correcting codes and Cyclic Redundancy Checks (CRC). These methods are effective at detecting and even correcting random data errors. However, they do not address cyber security issues where the data may be deliberately corrupted in a manner where the checking mechanism is also defeated. For example the CRC for the corrupted data value could be calculated and used to replace the CRC of the original data along with replacing the original data. These mechanisms might also not be effective after the data has been decoded in the system and the CRCs or other protective layers removed from the data.

Existing efforts to address cyber security in aircraft have focused on adding security protections to the primary avionics to preclude outside actors from gaining access and intentionally corrupting data. These techniques typically rely on trusted actors within the aircraft operating organization to perform maintenance and maintain security of access mechanisms, such as passwords. Thus, these techniques are susceptible to the potential for undiscovered cyber security threats and for even trusted actors to act in a malicious manner.

The present disclosure is directed to systems and methods for addressing these goals and interests. Thus, techniques discussed herein disclose systems and methods for detecting data corruption in connected vehicle systems.

### SUMMARY OF THE DISCLOSURE

According to certain aspects of the disclosure, systems, methods, and computer readable media are disclosed for detecting data corruption and tampering in vehicle data systems. Methods of detecting data corruption or tampering in vehicle data systems may include steps for receiving first electronic navigation plan data, the first electronic navigation plan data comprising a plurality of waypoints, and storing the first electronic navigation plan data in a data store. Methods may further comprise receiving second electronic navigation plan data from a vehicle management system, the second electronic navigation plan data comprising a second plurality of waypoints, and, upon determining a discrepancy between the first plurality of waypoints and the second plurality of waypoints, generating an alert indicating possible data corruption or tampering in the second electronic navigation plan.

According to certain aspects of the disclosure, systems, methods, and computer readable media are disclosed for detecting data corruption or tampering in aircraft data systems. Methods of detecting data corruption or tampering in aircraft data systems may include steps for receiving first electronic flight plan data, the first electronic flight plan data comprising a plurality of waypoints, and storing the first electronic flight plan data in a data store. Methods may further comprise receiving second electronic flight plan data from a flight management system, the second electronic flight plan data comprising a second plurality of waypoints, and, upon determining a discrepancy between the first plurality of waypoints and the second plurality of waypoints, generating an alert indicating possible data corruption or tampering in the second electronic flight plan.

Systems of detecting data corruption or tampering in aircraft data systems may comprise a data storage device storing instructions associated with aircraft data systems, and a processor configured to execute the instructions to perform a method comprising receiving first electronic flight plan data, the first electronic flight plan data comprising a plurality of waypoints. The method may further comprise storing the first electronic flight plan data in a data store, and receiving second electronic flight plan data from a flight management system, the second electronic flight plan data comprising a second plurality of waypoints. The method may further comprise, upon determining a discrepancy between the first plurality of waypoints and the second plurality of waypoints, generating an alert indicating possible data corruption or tampering in the second electronic flight plan.

Techniques discussed herein may include non-transitory computer-readable medium storing instructions that, when executed by a computer, cause the computer to perform a method of detecting data corruption or tampering in aircraft data systems, the method comprising receiving first electronic flight plan data, the first electronic flight plan data comprising a plurality of waypoints, and storing the first electronic flight plan data in a data store. The method may further comprise receiving second electronic flight plan data from a flight management system, the second electronic flight plan data comprising a second plurality of waypoints, and, upon determining a discrepancy between the first plurality of waypoints and the second plurality of waypoints, generating an alert indicating possible data corruption or tampering in the second electronic flight plan.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary data infrastructure for an aircraft system, according to techniques presented herein.

FIG. 2 depicts an exemplary infrastructure for an Enhanced Ground Proximity Warning System (EGPWS), according to techniques presented herein.

FIG. 3 depicts a flow chart of an exemplary method of detecting data corruption and/or tampering in aircraft data systems, according to techniques presented herein.

FIG. 4 depicts an example system that may execute techniques presented herein.

### DETAILED DESCRIPTION OF EMBODIMENTS

Various embodiments of the present disclosure relate generally to detecting data corruption and/or tampering in data systems and, more particularly, to monitoring data in aircraft systems for possible errors.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As described above, existing efforts to address cyber security in aircraft have focused on adding security protections to the primary avionics to preclude outside actors from gaining access and intentionally corrupting data. These techniques typically rely on trusted actors within the aircraft operating organization to perform maintenance and maintain security of access mechanisms, such as passwords. Given the potential for undiscovered cyber security threats and for even trusted actors to act in a malicious manner, the systems and methods described in the present disclosure are directed to an independent monitor of the aircraft primary avionics systems for alerting the crew to potential corruption of databases or sensor data. While this disclosure describes the systems and methods with reference to aircraft (e.g., aircraft primary avionics systems), it should be appreciated that the present systems and methods are applicable to security of any vehicle management systems, including those of drones, automobiles, trains (locomotives), or any other autonomous and/or Internet-connected vehicle.

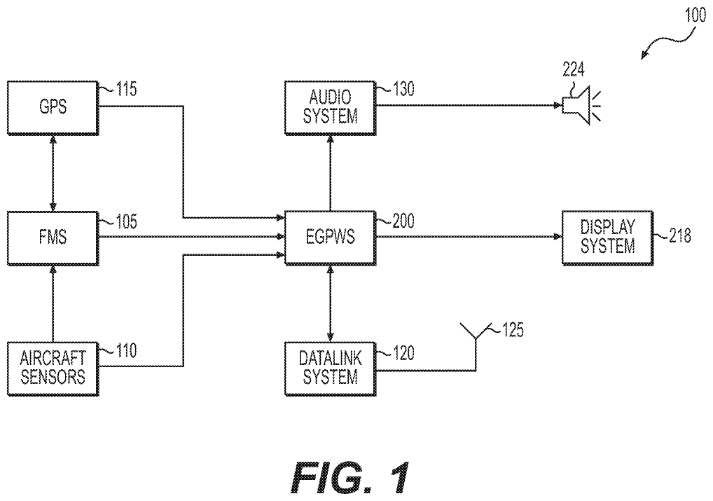

Referring now to the appended drawings, FIG. 1 depicts an exemplary data infrastructure for an aircraft system, according to techniques presented herein. In general, FIG. 1 depicts an exemplary data infrastructure system 100 for detecting data corruption of an aircraft system. As shown, exemplary data infrastructure system 100 comprises a global positioning system (“GPS”) 115, flight management system (“FMS”) 105, aircraft sensors 110, audio system 130, enhanced ground proximity warning system (or “EGPWS”) 200, datalink system 120, speaker 224, and display system 218.

A flight management system (or “FMS”) 105 may be any type of computer that acts as a type of navigation equipment, and may be configured for receiving input from a variety of other navigational instruments. Other navigational instruments may include aircraft sensors 110, such as inertial navigation instruments, radio navigational instruments, including one or more very high frequency omnidirectional radio range (VOR) systems, and global positioning system (GPS) 115. Aircraft sensors 110 may further comprise altitude data, heading data, air data reference, radar altimeter data, etc. Using this data, the FMS 105 may generate position information, and may further engage in in-flight management of a flight plan, which may be stored in an FMS database. Using FMS database data, the FMS 105 may calculate a course for the aircraft to follow, including a lateral flight plan and/or a vertical flight plan.

The enhanced ground proximity warning system (EGPWS) 200 is configured to alert pilots if their aircraft is in immediate danger of flying into the ground or an obstacle. EGPWS 200 may receive data from many aircraft systems including FMS 105, GPS 115, and/or aircraft sensors 110, such as air data, radar altimeter, inertial system, etc. EGPWS 200 may be configured to communicate with datalink 120, the data link having one or more antenna 125. EGPWS 200 may further communicate with audio system 130, which may produce an audio output at one or more speakers 224, which may comprise, for example, an audible alarm if the airplane altitude falls below a threshold. FMS 105 and/or EGPWS 200 may be associated with at least one display system 218, which may display flight path information, location information, ground proximity data, temperature data, aircraft sensor data, etc., to the crew.

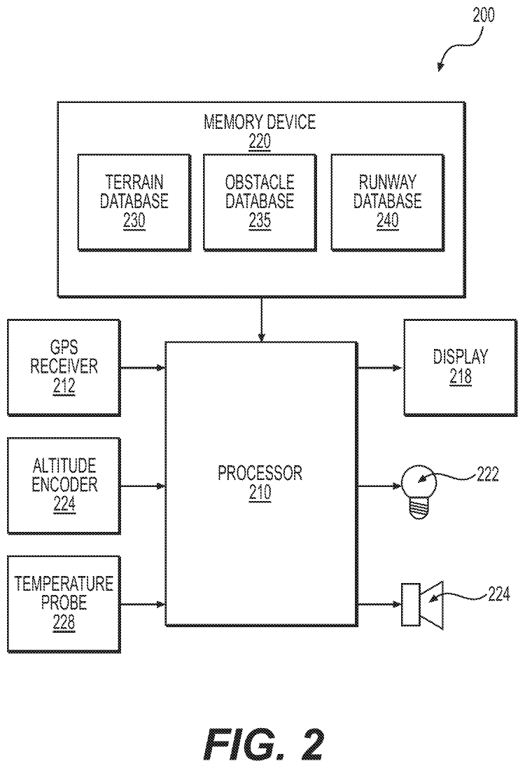

FIG. 2 depicts an exemplary infrastructure for EGPWS 200, according to techniques presented herein. In one embodiment, EGPWS 200 may have a memory or data store 220 comprising an independent copy of one or more of aircraft databases, including a terrain database 230, obstacle database 235, and navigation and/or runway database 240. EGPWS 200 may further comprise a processor 210, GPS receiver 212, altitude encoder 224, temperature probe 228, display 218, alert/light 222, and speaker 224. The EGPWS 200 may also include a set of input and/or output (IO) paths for monitoring data on aircraft data busses. The IO may include analog signals, discrete signals, Arinc 429, RS-422, and/or RS-232 data, and/or Ethernet databuses. Processor 210 may be configured to retrieve data from memory and/or data stores 220, and/or receive data from aircraft sensors 100, to perform techniques presented herein. Processor 210 may be configured to produce outputs to display 218, such as to a computer screen, outputs to one or more indicator lights 222, and/or outputs to one or more audio speakers 224.

EGPWS 200 may be associated with, and transmit and receive data to and from, a separate array of sensors, which may be embedded, such as GPS receiver 212, altitude encoder 224, and/or temperature probe 228, any of which may be embedded in the EGPWS 200 or separate from EGPWS 200. These sensors may be independent or duplicates of sensors associated with the FMS 105, or other aircraft sensors. EGPWS 200 may be configured to use these independent database copies and connections to aircraft sensors to monitor other aircraft systems, such as FMS 105, and provide alerts to the crew and/or ground in the event of a discrepancy. EGPWS 200 may share a display with FMS 105, or there may be separate displays. The display 218 of EGPWS 200 may be used to provide alerts to the crew. Potential cyber security issues could also be provided to this display.

For example, in one embodiment, FMS 105 may transmit flight plan information to display system 218 as well as to EGPWS 200. If, for example, any of the waypoints transmitted by FMS 105 are in a different location than is shown in the EGPWS 200 copy of the navigation database, the EGPWS 200 could provide an alert to the crew and/or off-plane personnel and/or system. Likewise, the EGPWS 200 may work to generate its own composite altitude estimate using a range of sensor inputs including inertial altitude, barometric altitude, GPS altitude, and/or radar altitude, etc. Discrepancies between these various sensors could be used to alert the crew. In this manner, the EGPWS 200 may cross-check for errors within its own systems and/or compare with systems of FMS 105.

Because EGPWS 200 may be mandated to be installed on most commercial aircraft, techniques described herein may be broadly applicable in the commercial sector. Having said that, any other equivalent to EGPWS 200 may be applicable to the techniques and methods of the present disclosure, whether in a military or automotive context, for example, with respect to a threat detection or vehicle collision detection/avoidance system, respectively.

In another embodiment, EGPWS 200 may utilize an off-aircraft datalink system 120 to validate aircraft data against data available from one or more remote services. For example, in the event that EGPWS 200 detects a discrepancy between waypoint coordinates transmitted by FMS 105 and the local copy in the EGPWS memory device 220, EGPWS 200 may be configured to contact a ground station via datalink system 120 to independently validate which version was correct. This might not only avoid nuisance alerts to the crew, but may potentially provide an independent path for updating databases of EGPWS 200.

A datalink-connected EGPWS 200 may also be configured to validate flight plans that are uplinked to the aircraft via datalink system 120. Currently, aircraft may receive updated flight plans from air traffic control (ATC), airline operations centers, or other flight planning services via the aircraft communications addressing and reporting system (ACARS) network. The pilot may be responsible for checking the uploaded flight plan before accepting it; however, there might not be a means for the pilot to validate all the received data. A connected EGPWS 200 may be configured to transmit the FMS 105 flight plan to the ground or else receive an independent copy of the flight plan from the ground. A check may then be performed by either the EGPWS 200 or a ground service to ensure that the correct flight plan is loaded and that it was not corrupted as part of the datalink process in sending it to the aircraft.

Much of the disclosed monitor functionality may be implemented as a software update to existing EGPWS systems. In one embodiment, a connected EGPWS 200 may be implemented using a datalink 120 that is independent of the links used by the aircraft primary avionics. Thus, it may be very difficult for a malicious actor to independently corrupt two separate communications paths at the same time. Such an independent communication path may use totally independent communication technologies or mechanisms. For example, the EGPWS 200 may use an Iridium satcom datalink system while the primary avionics may be using an Inmarsat satcom or very high frequency (VHF) radio datalink. In one embodiment, a virtual private network (VPN) connection may be used over a common satcom as it would be difficult to simultaneously corrupt two independent VPN connections. To be independent, the two VPN connections may use independent software created by separate teams to minimize the potential for identical vulnerabilities existing in both connections.

EGPWS-associated data may be checked against FMS 105 data and/or other data at predetermined time intervals. Alternatively, data may be checked for discrepancies at predetermined events, such as whenever a waypoint in the flight plan is reached. If, upon identifying a discrepancy, the discrepancy is below a predetermined threshold of difference, an alert might not be raised and/or the EGPWS might not request a data check from one or more off-aircraft data systems. Alternatively, multiple thresholds may be put in place. If a first lower threshold of data difference is detected between EGPWS-associated data and FMS 105 data and/or other data, a data check against one or more off-aircraft data systems may be performed. If a second threshold of data difference is exceeded, an alert to the crew may be automatically generated, while a data check against one or more off-aircraft data systems may further be performed.

Types of data discrepancies may cause different actions. For example, discrepancies between EGPWS-associated heading and FMS heading data beyond a threshold may cause an off-aircraft data check. Discrepancies between EGPWS-associated altitude and FMS altitude data beyond a threshold may automatically trigger an alert to the crew, where the alert may be provided before a possible off-aircraft data check.

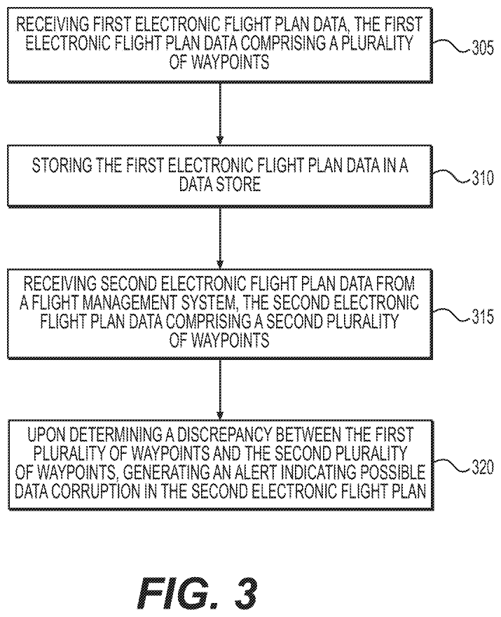

FIG. 3 depicts a flow chart of an exemplary method for detecting data corruption in aircraft data systems, according to techniques presented herein. At step 305, a first electronic flight plan data may be received, the first electronic flight plan data comprising a plurality of waypoints. At step 310, the first electronic flight plan data may be stored in a data store. At step 315, a second electronic flight plan data may be received from a flight management system, the second electronic flight plan data comprising a second plurality of waypoints. At step 320, upon determining a discrepancy between the first plurality of waypoints and the second plurality of waypoints, an alert may be generated indicating possible data corruption in the second electronic flight plan. While waypoints are discussed as examples herein, the data may alternatively or additionally include, for example, frequencies for tuning navigation aids, altitudes of terrain, airspeed restrictions, routes, procedure or sequences of waypoints, restricted airspace boundaries, aircraft performance data, and/or Notices to Airman (NOTAMs). Other forms of vehicle data may be used in conjunction with techniques discussed herein.

Using techniques presented herein, cybersecurity in aircraft systems may be enhanced. Data of the flight management system 105 may be checked against independent and corresponding data of the EGPWS 200. Further, aircraft sensors and position data associated with the flight management system 200 may be checked against independent aircraft sensors and position data stored in or associated with the EGPWS 200. The EGPWS 200 may further validate database, flight plan, and/or aircraft sensor and position data via independent communication with data sources on the ground. In this manner the EGPWS may act in the background to validate data automatically, and provide double-checks without necessarily alerting the crew and/or ground. Authorized users may set one or more thresholds to indicate how data checks and/or alerts may be generated. In these and other ways discussed herein, the technical field is improved.

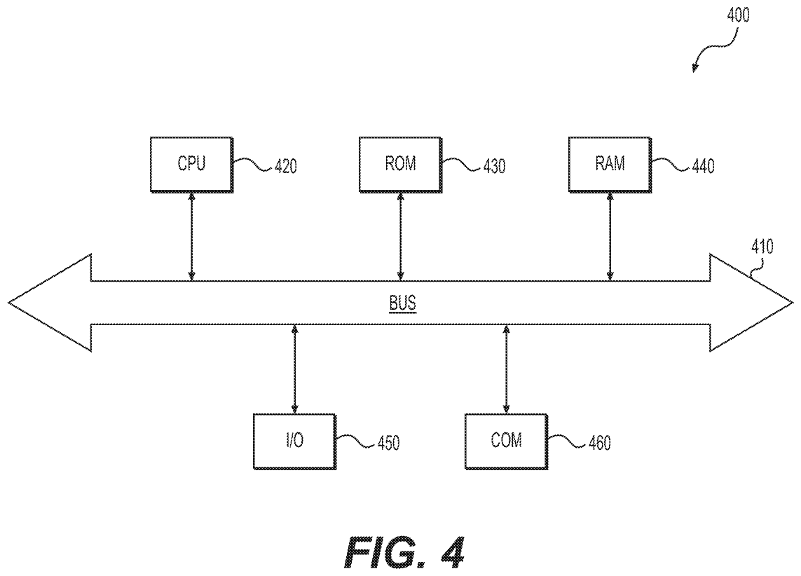

FIG. 4 is a simplified functional block diagram of a computer that may be configured as any of the systems of FIG. 1 to execute techniques described herein, according to exemplary embodiments of the present disclosure. Specifically, in one embodiment, any of the aircraft systems 100, including the EGPWS 200 and/or FMS 105, may be an assembly of hardware 400 including, for example, a data communication interface 460 for packet data communication. The platform may also include a central processing unit (“CPU”) 420, in the form of one or more processors, for executing program instructions. The platform may include an internal communication bus 410, program storage, and data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

Any suitable system infrastructure may be put into place to allow for the assessment of models monitoring devices. FIG. 1 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 1. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of detecting data corruption or tampering in vehicle data systems, comprising:
receiving first electronic navigational plan data, the first electronic navigational plan data comprising a plurality of waypoints;
storing the first electronic navigational plan data in a data store;
receiving second electronic navigational plan data from a vehicle management system, the second electronic navigational plan data comprising a second plurality of waypoints; and
upon determining a discrepancy between the first plurality of waypoints and the second plurality of waypoints, generating an alert indicating possible data corruption or tampering in the second electronic navigational plan.

2. The method of claim 1, further comprising:
determining whether a discrepancy exists between the first plurality of waypoints, the second plurality of waypoints, and a third plurality of waypoints by communicating with a data link, the data link communicating with an off-plane data source.

3. The method of claim 2, wherein the data link communicating with the off-plane data source is a separate data link from a second data link associated with the vehicle management system.

4. The method of claim 3, wherein the data link communicating with the off-plane data source uses a different communications technology than the second data link associated with the vehicle management system.

5. The method of claim 4, wherein the data link communicating with the off-plane data source utilizes a virtual private network, and wherein the virtual private network is different from a second virtual private network associated with a second data link, the second data link being associated with the vehicle management system.

6. The method of claim 1, further comprising:
providing the first plurality of waypoints and the second plurality of waypoints to a data link, the data link communicating with an off-plane data source, the off-plane data source determining whether a discrepancy exists between the first plurality of waypoints, the second plurality of waypoints, and a third plurality of waypoints.

7. The method of claim 1, further comprising:
redetermining whether a discrepancy exists between the first plurality of waypoints and the second plurality of waypoints at a predetermined time interval.

8. A system of detecting data corruption or tampering in vehicle data systems, the system comprising:
a data storage device storing instructions associated with vehicle data systems; and
a processor configured to execute the instructions to perform a method including
receiving first electronic navigational plan data, the first electronic navigational plan data comprising a plurality of waypoints;
storing the first electronic navigational plan data in a data store;
receiving second electronic navigational plan data from a vehicle management system, the second electronic navigational plan data comprising a second plurality of waypoints; and
upon determining a discrepancy between the first plurality of waypoints and the second plurality of waypoints, generating an alert indicating possible data corruption or tampering in the second electronic navigational plan.

9. The system of claim 8, wherein the processor is further configured for:
determining whether a discrepancy exists between the first plurality of waypoints, the second plurality of waypoints, and a third plurality of waypoints by communicating with a data link, the data link communicating with an off-plane data source.

10. The system of claim 9, wherein the data link communicating with the off-plane data source is a separate data link from a second data link associated with the vehicle management system.

11. The system of claim 10, wherein the data link communicating with the off-plane data source uses a different communications technology than the second data link associated with the vehicle management system.

12. The system of claim 11, wherein the data link communicating with the off-plane data source utilizes a virtual private network, and wherein the virtual private network is different from a second virtual private network associated with a second data link, the second data link being associated with the vehicle management system.

13. The system of claim 8, the processor is further configured for:
providing the first plurality of waypoints and the second plurality of waypoints to a data link, the data link communicating with an off-plane data source, the off-plane data source determining whether a discrepancy exists between the first plurality of waypoints, the second plurality of waypoints, and a third plurality of waypoints.

14. The system of claim 8, the processor is further configured for:
redetermining whether a discrepancy exists between the first plurality of waypoints and the second plurality of waypoints at a predetermined time interval.

15. A non-transitory computer-readable medium storing instructions that, when executed by a computer, cause the computer to perform a method of detecting data corruption or tampering in vehicle data systems, the method comprising:
receiving first electronic navigational plan data, the first electronic navigational plan data comprising a plurality of waypoints;
storing the first electronic navigational plan data in a data store;
receiving second electronic navigational plan data from a vehicle management system, the second electronic navigational plan data comprising a second plurality of waypoints; and
upon determining a discrepancy between the first plurality of waypoints and the second plurality of waypoints, generating an alert indicating possible data corruption or tampering in the second electronic navigational plan.

16. The computer-readable medium of claim 15, the method further comprising:
determining whether a discrepancy exists between the first plurality of waypoints, the second plurality of waypoints, and a third plurality of waypoints by communicating with a data link, the data link communicating with an off-plane data source.

17. The computer-readable medium of claim 16, wherein the data link communicating with the off-plane data source is a separate data link from a second data link associated with the vehicle management system.

18. The computer-readable medium of claim 17, wherein the data link communicating with the off-plane data source uses a different communications technology than the second data link associated with the vehicle management system.

19. The computer-readable medium of claim 18, wherein the data link communicating with the off-plane data source utilizes a virtual private network, and wherein the virtual private network is different from a second virtual private network associated with a second data link, the second data link being associated with the vehicle management system.

20. The computer-readable medium of claim 15, the method further comprising:
providing the first plurality of waypoints and the second plurality of waypoints to a data link, the data link communicating with an off-plane data source, the off-plane data source determining whether a discrepancy exists between the first plurality of waypoints, the second plurality of waypoints, and a third plurality of waypoints.
